(19) United States
(12) Patent Application Publication
(10) Pub. No.: US 2025/0056422 A1
(43) Pub. Date: Feb. 13, 2025

(54) Methods and systems for implementing quality of service in low power wide area networks

(71) Applicant: Everynet Oy, Espoo (FI)

(72) Inventor: Vitaly Kleban, Espoo (FI)

(21) Appl. No.: 18/720,750

(22) PCT Filed: Nov. 28, 2022
(86) PCT No.: PCT/FI2022/050793

§ 371 Date: Jun. 17, 2024

Related U.S. Application Data
(60) Provisional application No. 63/289,648, filed on Dec. 15, 2021.

(51) Int. Cl. H04W 52/26; H04W 52/42

(52) U.S. Cl. CPC H04W 52/267; H04W 52/42

(57) ABSTRACT

According to an example aspect of the present invention, there are provided methods and devices for quality of service implementation in a server of a low power wide area network (LPWAN) by determining a reference signal quality value based on the signal quality values of received messages, comparing the reference signal quality value with a predefined limit, defining a target data rate for messages from the end device at least partly based on the comparison of the reference signal quality value with the predefined limit, defining a target transmission power for messages from the end device at least partly based on the comparison of the reference signal quality value with the predefined limit, and transmitting at least one of the defined target data rate and target transmission power to the end device. Wherein determining the reference signal quality value includes grouping the signal quality values by propagation channel, determining a performance of each propagation channel, selecting a quality of service parameter M, wherein M is an integer greater than zero, selecting the Mth best propagation channel based on the determined performance, and determining the reference signal quality value based on the signal quality values associated with the selected propagation channel.

### BACKGROUND

Low power wide area networks (LPWAN) employ end devices, gateways, and servers in order to collect data. This collection of data is provided via messages, sometimes called uplink message, from the end devices that are broadcast from the end devices, received by the gateways, and then forwarded to the server or servers. In this fashion, LPWANs can monitor utility consumption, track assets, and provide for contact tracing among other solutions.

In certain solutions, LPWANs employ Adaptive Data Rate (ADR) mechanisms to optimize data rates and energy consumption within end devices. Within current ADR solutions, the network server may indicate to the end device that it should reduce transmission power or increase data rate. In order to determine the optimal data rate, the server relies a maximum signal-to-noise ratio (SNR) from the 20 most recent uplinks. In this fashion, end devices which are close to gateways would use a higher data rate, while devices further away would use a lower data rate.

Within LPWANs, including LoRaWAN networks, where end devices are paired with a network and not exclusively tied to a single gateway, end devices will broadcast uplink messages that are received by any number of gateways for forwarding to a server that will then de-duplicate any multiply received uplink message.

### SUMMARY OF THE INVENTION

The invention is defined by the features of the independent claims. Some specific embodiments are defined in the dependent claims.

According to a first aspect of the present invention, there is provided a method for quality of service implementation in a server of a low power wide area network (LPWAN), the method comprising the steps of: receiving, in the server, a plurality of messages from an end device of the LPWAN, the plurality of messages each having an associated signal quality value and data rate, determining a reference signal quality value based on the signal quality values, comparing the reference signal quality value with a predefined limit, defining a target data rate for messages from the end device at least partly based on the comparison of the reference signal quality value with the predefined limit, defining a target transmission power for messages from the end device at least partly based on the comparison of the reference signal quality value with the predefined limit, and transmitting at least one of the defined target data rate and target transmission power to the end device, wherein determining the reference signal quality value comprises: grouping the signal quality values by propagation channel, determining a performance of each propagation channel, selecting a quality of service parameter M, wherein M is an integer greater than zero, selecting the Mth best propagation channel based on the determined performance, and determining the reference signal quality value based on the signal quality values associated with the selected propagation channel.

According to a second aspect of the present invention, there is provided a method for broadcast optimization in a low power wide area network (LPWAN) comprising at least an end device, a plurality of gateways and a server, the method comprising the steps of: receiving, in the server, a plurality of messages broadcast from the end device, the plurality of messages each having an associated signal quality value and data rate, determining a reference signal quality value based on the signal quality values, comparing the reference signal quality value with a predefined limit, defining a target data rate for messages from the end device at least partly based on the comparison of the reference signal quality value with the predefined limit, defining a target transmission power for messages from the end device at least partly based on the comparison of the reference signal quality value with the predefined limit, and transmitting at least one of the defined target data rate and target transmission power to the end device, wherein determining the reference signal quality value comprises: grouping the signal quality values by propagation channel, determining a performance of each propagation channel, selecting a quality of service parameter M, wherein M is an integer greater than zero, selecting the Mth best propagation channel based on the determined performance, and determining the reference signal quality value based on the signal quality values associated with the selected propagation channel.

According to a third aspect of the present invention, there is provided a server for a low power wide area network (LPWAN), the server comprising at least one processing core, at least one memory including computer program code, the at least one memory and the computer program code being configured to, with the at least one processing core, cause the server at least to: receive, in the server, a plurality of messages from an end device of the LPWAN, the plurality of messages each having an associated signal quality value and data rate, determine a reference signal quality value based on the signal quality values, compare the reference signal quality value with a predefined limit, define a target data rate for messages from the end device at least partly based on the comparison of the reference signal quality value with the predefined limit, define a target transmission power for messages from the end device at least partly based on the comparison of the reference signal quality value with the predefined limit, and transmit at least one of the defined target data rate and target transmission power to the end device wherein determining the reference signal quality value comprises: grouping the signal quality values by propagation channel, determining a performance of each propagation channel, selecting a quality of service parameter M, wherein M is an integer greater than zero, selecting the Mth best propagation channel based on the determined performance, and determining the reference signal quality value based on the signal quality values associated with the selected propagation channel.

### BRIEF DESCRIPTION OF THE DRAWINGS

FIG. 1 illustrates an example Low Power Wide Area network (LPWAN) capable of supporting at least some embodiments of the present invention;

FIGS. 2A and 2B show an example LPWAN capable of supporting at least some embodiments of the present invention, and

FIG. 3 illustrates an example apparatus capable of supporting at least some embodiments of the present invention.

### EMBODIMENTS

Quality of Service schemes according to embodiments of the present invention provide for adjustment of the data rate and transmission power of end devices within a LPWAN while maintaining quality of service by analyzing messages received from an end device and adjusting parameters of the end device using a variety of methods, including but not limited to: consideration for propagation channels, statistical analysis of historical signal quality values and redundancy considerations.

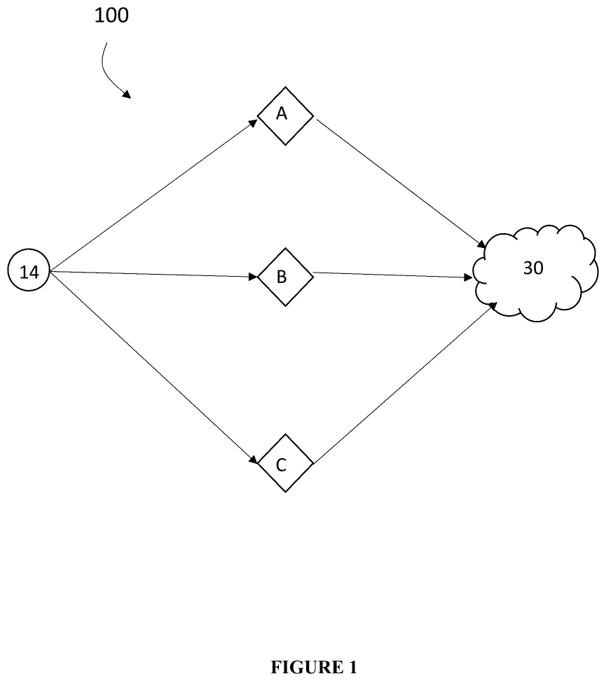

FIG. 1 illustrates an example Low Power Wide Area network (LPWAN) capable of supporting at least some embodiments of the present invention. As seen, an end device 14 of the LPWAN 100 may broadcast messages which are received by at least one of the three gateways A, B, C and forwarded by said gateways to server 30. This process may also refer to the route the message takes to or from the server as a propagation channel. Within FIG. 1 there would be three propagation channels A, B, C.

Within the LPWAN messages received in the server would be tagged or associated with a variety of data, including but not limited to: the propagation channel used, a signal quality of the received message, the data rate of the message and the transmission power used to send the message.

As an example of signal quality and propagation channel tracking, the following would represent the receipt records of two messages, M1 and M2 via propagation channels A, B, C and the associated signal quality for each. In this example a signal to noise ratio is used, but a variety of signal quality metrics may be employed.

| Message | Propagation Channel | Signal to Noise Ratio (SNR) |
|---|---|---|
| M1 | A | 2 |
| M1 | B | 3 |
| M1 | C | 10 |
| M2 | A | 2 |
| M2 | B | 5 |
| M2 | C | — |

As shown, the first message, M1, was received in the server via all three propagation channels. In contrast, the second message, M2, was only received via propagation channels A and B.

At least some embodiments of the present invention provide for a method for quality of service implementation in a server of a low power wide area network (LPWAN). The method comprising the steps of: receiving, in the server, a plurality of messages from an end device of the LPWAN, the plurality of messages each having an associated signal quality value and data rate, determining a reference signal quality value based on the signal quality values, comparing the reference signal quality value with a predefined limit, defining a target data rate for messages from the end device at least partly based on the comparison of the reference signal quality value with the predefined limit, defining a target transmission power for messages from the end device at least partly based on the comparison of the reference signal quality value with the predefined limit, and transmitting at least one of the defined target data rate and target transmission power to the end device, wherein determining the reference signal quality value comprises: grouping the signal quality values by propagation channel, determining a performance of each propagation channel, selecting a quality of service parameter M, wherein M is an integer greater than zero, selecting the Mth best propagation channel based on the determined performance, and determining the reference signal quality value based on the signal quality values associated with the selected propagation channel.

Selecting the Mth or Nth value, may comprise, for example, selecting from among a plurality of values such that within the values there are exactly M−1 or N−1 options larger than the selected value within the plurality. For example, selecting the Mth best propagation channel based on the determined performance may comprise ranking the propagation channels by performance into a list and selecting the propagation channel from the list such that there are exactly M−1 channels about the selected channel in the list. In example embodiments, the quality of service parameter M is greater than 1 or limited to values greater than 1. In certain embodiments M is a function of the determined performance of each propagation channel.

Within certain embodiments, determining the reference signal quality comprises: selecting a quality of service parameter N, wherein N is an integer greater than zero, and selecting the Nth largest signal quality value from the selected propagation channel as the reference signal quality. In certain example embodiments N is limited to values greater than 1.

Reference signal qualities may be determined, for example, as a function of received signal quality values. For example, the reference signal quality value may be the median of the signal quality values associated with the selected propagation channel. As another example, the reference signal quality value may be based on a quantile of the signal quality values associated with the selected propagation channel, such as a percentile, quartile or octile, for example the first quartile. For example, the reference signal quality value may be a percentile, such as a 90th percentile or 75th percentile. In at least some cases the reference signal quality value is calculated from the formula: reference signal quality value=quantile (signal quality values associated with the selected propagation channel, q) wherein q is a predetermined variable and for example, if q=0.75, 75% of the values are below the determined value.

Predefined limits may be derived from a variety of parameters. Within certain embodiments, the predefined limit comprises a table of signal quality values and associated data rates. Such tables may be, for example, manufacturer supplied minimum signal qualities for given data rates. Tables may be associated with individual end devices, for example, in a LPWAN with a variety of end devices, a server may use different predefined limits for different end devices.

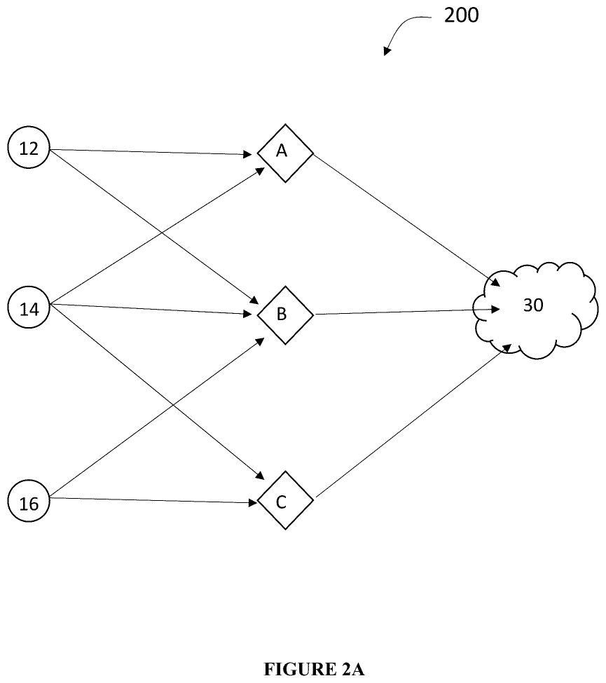

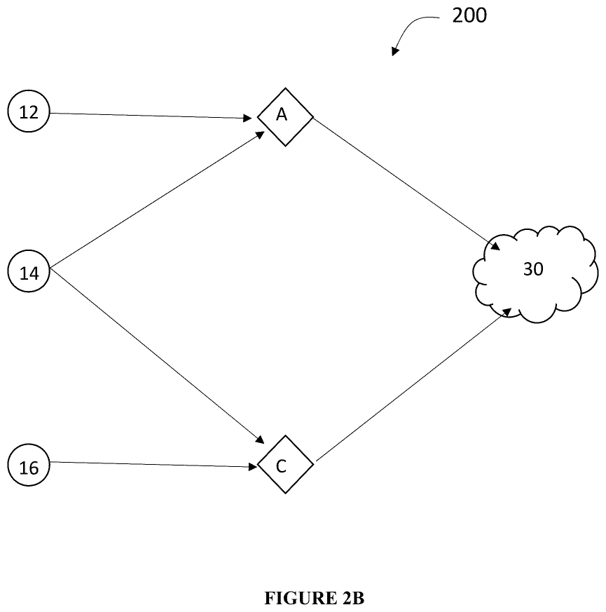

FIG. 2A shows an example LPWAN capable of supporting at least some embodiments of the present invention. Within FIG. 2A the LPWAN 200, comprises three end devices: 12, 14, 16; three gateways: A, B, C; and a server 30. Within the LPWAN, messages broadcast by end device 12 may be received in either gateway A or B as shown. Similarly, messages of end device 14 may be received by any of gateways A, B and C, with messages of end device 16 being received by either B or C. This could be due to, for example, the relative geographical locations of the end devices and gateways, the broadcast parameters selected for each end device or any number of reasons that certain propagation channels are available for certain end devices.

Within embodiments of the present invention, message broadcast parameters for the end devices may be selected such that message broadcast by the end device would be received by multiple gateways. For example, end device 12 may be instructed to broadcast with a data rate and transmission power such that message are received in a predefined number of gateways. This may be references as a Quality of Service (Qos) parameter. M in the embodiment discussed above may be considered a quality of service parameter.

Within certain embodiments, QoS may range from 1 to 3, with 1 meaning only the best gateway is employed, 2 meaning that the best 2 gateways are employed and 3 meaning that the top 3 gateways are employed. Employing the best 2 gateways may be useful in high availability situations, for example when the end device enables billing for service, such as a utility. Employing the top 3 gateways may find use in mission critical infrastructure, such as a fire alarm or smart meter. Referring to FIG. 2A, end devices 12 and 16 would have a QoS 2, with end device 14 having QoS 3.

Within FIG. 2B, gateway B has become unavailable. This could be due to a power outage, radio interference, a lost connection to server 30 or a variety of other reasons. However, as the broadcast parameters, for example data rate and transmission power, of the end devices has been selected according to embodiments of the present invention, even the loss of gateway B has not resulted in an interruption in message receipt from the end devices 12, 14 and 16. As can be seen, end device 12 still has a functioning propagation channel via gateway A. Likewise messages of end device 16 may still be received via gateway C. End device 14, would still have two propagation channels and therefore would still have redundancy even with the loss of a single gateway. Within certain embodiments each of the end devices would have an assigned QoS parameter and when one gateway becomes unavailable, the broadcast parameters of the end devices are adjusted to bring the number of potential propagation channels back to that dictated by the assigned QoS parameter.

According to certain embodiments, the target data rate and target transmission power are selected such that they will enable demodulation of a message signal received from the end device.

Within embodiments the signal quality value may be selected or derived from at least one of: a Signal to Noise Ratio (SNR), a Received Signal Strength Indicator (RSSI), a Packet Error Rate (PER), or a function thereof. For example the signal quality value may be a function of at least one of: SNR, RSSI and PER.

At least some embodiments provide for a non-transitory computer readable medium having stored thereon a set of computer readable instructions that, when executed by at least one processor, cause a server of an LPWAN to at least perform a method described herein.

Certain embodiments provide for a computer program configured to cause a method described herein.

At least some embodiments provide for a method for broadcast optimization in a low power wide area network (LPWAN) comprising at least an end device, a plurality of gateways and a server, the method comprising the steps of: receiving, in the server, a plurality of messages broadcast from the end device, the plurality of messages each having an associated signal quality value and data rate, determining a reference signal quality value based on the signal quality values, comparing the reference signal quality value with a predefined limit, defining a target data rate for messages from the end device at least partly based on the comparison of the reference signal quality value with the predefined limit, defining a target transmission power for messages from the end device at least partly based on the comparison of the reference signal quality value with the predefined limit, and transmitting at least one of the defined target data rate and target transmission power to the end device, wherein determining the reference signal quality value comprises: grouping the signal quality values by propagation channel, determining a performance of each propagation channel, selecting a quality of service parameter M, wherein M is an integer greater than zero, selecting the Mth best propagation channel based on the determined performance, and determining the reference signal quality value based on the signal quality values associated with the selected propagation channel.

Some embodiments provide for a server for a low power wide area network (LPWAN), the server comprising at least one processing core, at least one memory including computer program code, the at least one memory and the computer program code being configured to, with the at least one processing core, cause the server at least to: receive a plurality of messages from an end device of the LPWAN, the plurality of messages each having an associated signal quality value and data rate, determine a reference signal quality value based on the signal quality values, compare the reference signal quality value with a predefined limit, define a target data rate for messages from the end device at least partly based on the comparison of the reference signal quality value with the predefined limit, define a target transmission power for messages from the end device at least partly based on the comparison of the reference signal quality value with the predefined limit, and transmit at least one of the defined target data rate and target transmission power to the end device, wherein determining the reference signal quality value comprises: grouping the signal quality values by propagation channel, determining a performance of each propagation channel, selecting a quality of service parameter M, wherein M is an integer greater than zero, selecting the Mth best propagation channel based on the determined performance, and determining the reference signal quality value based on the signal quality values associated with the selected propagation channel.

Certain embodiments provide for a server for a low power wide area network (LPWAN) comprising: means for receiving, in the server, a plurality of messages from an end device of the LPWAN, the plurality of messages each having an associated signal quality value and data rate, means for determining a reference signal quality value based on the signal quality values, means for comparing the reference signal quality value with a predefined limit, means for defining a target data rate for messages from the end device at least partly based on the comparison of the reference signal quality value with the predefined limit, means for defining a target transmission power for messages from the end device at least partly based on the comparison of the reference signal quality value with the predefined limit, and means for transmitting at least one of the defined target data rate and target transmission power to the end device, wherein determining the reference signal quality value comprises: grouping the signal quality values by propagation channel, determining a performance of each propagation channel, selecting a quality of service parameter M, wherein M is an integer greater than zero, selecting the Mth best propagation channel based on the determined performance, and determining the reference signal quality value based on the signal quality values associated with the selected propagation channel.

At least some embodiments provide for a non-transitory computer readable medium having stored thereon a set of computer readable instructions that, when executed by at least one processor, cause a server of an LPWAN to at least: receive, in the server, a plurality of messages from an end device of the LPWAN, the plurality of messages each having an associated signal quality value and data rate, determine a reference signal quality value based on the signal quality values, compare the reference signal quality value with a predefined limit, define a target data rate for messages from the end device at least partly based on the comparison of the reference signal quality value with the predefined limit, define a target transmission power for messages from the end device at least partly based on the comparison of the reference signal quality value with the predefined limit, and transmit at least one of the defined target data rate and target transmission power to the end device, wherein determining the reference signal quality value comprises: grouping the signal quality values by propagation channel, determining a performance of each propagation channel, selecting a quality of service parameter M, wherein M is an integer greater than zero, selecting the Mth best propagation channel based on the determined performance, and determining the reference signal quality value based on the signal quality values associated with the selected propagation channel.

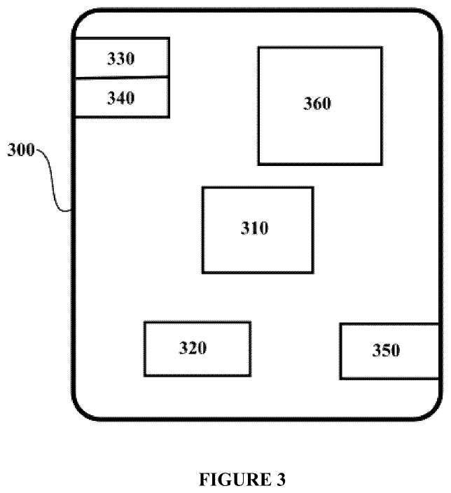

FIG. 3 illustrates an example apparatus capable of supporting at least some embodiments of the present invention. Illustrated is device 300, which may comprise, for example: any of the participants in a LPWAN systems discussed herein, such as: an end device, gateway or server. Comprised in device 300 is processor 310, which may comprise, for example, a single- or multi-core processor wherein a single-core processor comprises one processing core and a multi-core processor comprises more than one processing core. Processor 310 may comprise a Qualcomm Snapdragon 800 processor, for example. Processor 310 may comprise more than one processor. A processing core may comprise, for example, a Cortex-A8 processing core manufactured by Intel Corporation or a Brisbane processing core produced by Advanced Micro Devices Corporation. Processor 310 may comprise at least one application-specific integrated circuit, ASIC. Processor 310 may comprise at least one field-programmable gate array, FPGA. The aforementioned processor types are non-limiting examples, alternatively an Intel i7 processor, or another suitable type of processor, may be employed.

Device 300 may comprise memory 320. Memory 320 may comprise random-access memory and/or permanent memory. Memory 320 may comprise at least one RAM chip. Memory 320 may comprise magnetic, optical and/or holographic memory. Memory 320 may be at least in part accessible to processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions.

Device 300 may comprise a transmitter 330. Device 300 may comprise a receiver 340. Transmitter 330 and receiver 340 may be configured to transmit and receive, respectively, information in accordance with systems, for example, transmitter 330 may transmit information to a monitor for display to a user, and/or receiver 340 may receive input information concerning a location and/or orientation of a further device.

Device 300 may comprise a near-field communication, NFC, transceiver 350. NFC transceiver 350 may support at least one NFC technology, such as NFC, Bluetooth, Wibree or similar technologies.

Device 300 may comprise user interface, UI, 360. UI 360 may comprise at least one of a display, a keyboard and a touchscreen. A user may be able to operate device 300 via UI 360, for example to start or terminate execution of programs.

Processor 310 may be furnished with a transmitter arranged to output information from processor 310, via electric leads internal to device 300, to other devices comprised in device 300. Such a transmitter may comprise a serial bus transmitter arranged to, for example, output information via at least one electric lead to memory 320 for storage therein. Alternatively, to a serial bus, the transmitter may comprise a parallel bus transmitter. Likewise, processor 310 may comprise a receiver arranged to receive information in processor 310, via electrical leads internal to device 300, from other devices comprised in device 300. Such a receiver may comprise a serial bus receiver arranged to; for example, receive information via at least one electric lead from receiver 340 for processing in processor 310. Alternatively, to a serial bus, the receiver may comprise a parallel bus receiver.

Device 300 may comprise further devices not illustrated in FIG. 3. For example, where device 300 comprises a computer device, it may comprise at least one clock or auxiliary power unit, APU to provide battery power in case of mains power failure.

Processor 310, memory 320, transmitter 330, receiver 340, NFC transceiver 350 and/or UI 360 may be interconnected by electric leads internal to device 300 in a multitude of different ways. For example, each of the aforementioned devices may be separately connected to a master bus internal to device 300, to allow the devices to exchange information. However, as the skilled person will appreciate, this is only one example and depending on the embodiment, various ways of interconnecting at least two of the aforementioned devices may be selected without departing from the scope of the present invention.

At least some embodiments of the present invention provide for the following clauses:

1. A method for quality of service implementation in a server of a low power wide area network (LPWAN), the method comprising the steps of:
receiving, in the server, a plurality of messages from an end device of the LPWAN, the plurality of messages each having an associated signal quality value and data rate,
determining a reference signal quality value based on the signal quality values,
comparing the reference signal quality value with a predefined limit,
defining a target data rate for messages from the end device at least partly based on the comparison of the reference signal quality value with the predefined limit,
defining a target transmission power for messages from the end device at least partly based on the comparison of the reference signal quality value with the predefined limit, and transmitting at least one of the defined target data rate and target transmission power to the end device,
   characterized in that determining the reference signal quality value comprises:
grouping the signal quality values by propagation channel,
determining a performance of each propagation channel,
selecting a quality of service parameter M, wherein M is an integer greater than zero,
selecting the Mth best propagation channel based on the determined performance, and
determining the reference signal quality value based on the signal quality values associated with the selected propagation channel.

2. The method of clause 1, wherein determining the reference signal quality further comprises:
selecting a quality of service parameter N, wherein N is an integer greater than zero, and
selecting the Nth largest signal quality value from the selected propagation channel as the reference signal quality.

3. The method of clause 2, wherein the quality of service parameter N is greater than 1.

4. The method of any preceding clause, wherein the reference signal quality is a function of received signal quality values.

5. The method of any preceding clause, wherein the quality of service parameter M is greater than 1.

6. The method of any preceding clause, wherein M is a function of the determined performance of each propagation channel.

7. The method of any preceding clause, wherein the reference signal quality value is the median of the signal quality values associated with the selected propagation channel.

8. The method of any preceding clause, wherein the reference signal quality value is a quantile of the signal quality values associated with the selected propagation channel.

9. The method of any preceding clause, wherein the predefined limit comprises a table of signal quality values and associated data rates.

10. The method of any preceding clause, wherein the target data rate and target transmission power are selected such that they will enable demodulation of a message signal received from the end device.

11. The method of any preceding clause, wherein the signal quality value is selected or derived from at least one of: a Signal to Noise Ratio (SNR), a Received Signal Strength Indicator (RSSI), a Packet Error Rate (PER), and their function.

12. A non-transitory computer readable medium having stored thereon a set of computer readable instructions that, when executed by at least one processor, cause a server of an LPWAN to at least perform the method of any of clauses 1-11.

13. A computer program configured to cause a method in accordance with at least one of clauses 1-11.

14. A method for broadcast optimization in a low power wide area network (LPWAN) comprising at least an end device, a plurality of gateways and a server, the method comprising the steps of:
receiving, in the server, a plurality of messages broadcast from the end device, the plurality of messages each having an associated signal quality value and data rate,
determining a reference signal quality value based on the signal quality values,
comparing the reference signal quality value with a predefined limit,
defining a target data rate for messages from the end device at least partly based on the comparison of the reference signal quality value with the predefined limit,
defining a target transmission power for messages from the end device at least partly based on the comparison of the reference signal quality value with the predefined limit, and
transmitting at least one of the defined target data rate and target transmission power to the end device,
   characterized in that determining the reference signal quality value comprises:
grouping the signal quality values by propagation channel,
determining a performance of each propagation channel,
selecting a quality of service parameter M, wherein M is an integer greater than zero,
selecting the Mth best propagation channel based on the determined performance, and
determining the reference signal quality value based on the signal quality values associated with the selected propagation channel.

15. The method of clause 14, wherein determining the reference signal quality further comprises:
selecting a quality of service parameter N, wherein N is an integer greater than zero, and
selecting the Nth largest signal quality value from the selected propagation channel as the reference signal quality.

16. The method of clause 15, wherein the quality of service parameter N is greater than 1.

17. The method of any of clauses 14-16, wherein the reference signal quality is a function of received signal quality values.

18. The method of any of clauses 14-17, wherein the quality of service parameter M is greater than 1.

19. The method of any of clauses 14-18, wherein M is a function of the determined performance of each propagation channel.

20. The method of any of clauses 14-19, wherein the reference signal quality value is the median of the signal quality values associated with the selected propagation channel.

21. The method of any of clauses 14-20, wherein the reference signal quality value is a quantile of the signal quality values associated with the selected propagation channel.

22. The method of any of clauses 14-21, wherein the predefined limit comprises a table of signal quality values and associated data rates.

23. The method of any preceding clause, wherein the target data rate and target transmission power are selected such that they will enable demodulation of a message signal received from the end device.

24. The method of any of clauses 14-23, wherein the signal quality value is selected or derived from at least one of: a Signal to Noise Ratio (SNR), a Received Signal Strength Indicator (RSSI), a Packet Error Rate (PER), and their function.

25. The method of any of clauses 14-24, wherein the end device broadcasts within the sub-Ghz radio frequency band.

26. A non-transitory computer readable medium having stored thereon a set of computer readable instructions that, when executed by at least one processor, cause at least one apparatus of an LPWAN to at least perform the method of any of clauses 14-25.

27. A computer program configured to cause a method in accordance with at least one of clauses 14-25.

28. A server for a low power wide area network (LPWAN), the server comprising at least one processing core, at least one memory including computer program code, the at least one memory and the computer program code being configured to, with the at least one processing core, cause the server at least to:
receive a plurality of messages from an end device of the LPWAN, the plurality of messages each having an associated signal quality value and data rate,
determine a reference signal quality value based on the signal quality values,
compare the reference signal quality value with a predefined limit, define a target data rate for messages from the end device at least partly based on the comparison of the reference signal quality value with the predefined limit,
define a target transmission power for messages from the end device at least partly based on the comparison of the reference signal quality value with the predefined limit, and
transmit at least one of the defined target data rate and target transmission power to the end device,
   characterized in that determining the reference signal quality value comprises:
grouping the signal quality values by propagation channel,
determining a performance of each propagation channel,
selecting a quality of service parameter M, wherein M is an integer greater than zero,
selecting the Mth best propagation channel based on the determined performance, and
determining the reference signal quality value based on the signal quality values associated with the selected propagation channel.

29. The server of clause 28, wherein determining the reference signal quality further comprises:
selecting a quality of service parameter N, wherein N is an integer greater than zero, and
selecting the Nth largest signal quality value from the selected propagation channel as the reference signal quality.

30. The server of clause 29, wherein the quality of service parameter N is greater than 1.

31. The server of any of clauses 28-30, wherein the reference signal quality is a function of received signal quality values.

32. The server of any of clauses 28-31, wherein the quality of service parameter M is greater than 1.

33. The server of any of clauses 28-32, wherein M is a function of the determined performance of each propagation channel.

34. The server of any of clauses 28-33, wherein the reference signal quality value is the median of the signal quality values associated with the selected propagation channel.

35. The server of any of clauses 28-34, wherein the reference signal quality value is a quantile of the signal quality values associated with the selected propagation channel.

36. The server of any of clauses 28-35, wherein the predefined limit comprises a table of signal quality values and associated data rates.

37. The server of any of clauses 28-36, wherein the target data rate and target transmission power are selected such that they will enable demodulation of a message signal received from the end device.

38. The server of any of clauses 28-37, wherein the signal quality value is selected or derived from at least one of: a Signal to Noise Ratio (SNR), a Received Signal Strength Indicator (RSSI), a Packet Error Rate (PER), and their function.

39. A server for a low power wide area network (LPWAN) comprising:
means for receiving, in the server, a plurality of messages from an end device of the LPWAN, the plurality of messages each having an associated signal quality value and data rate,
means for determining a reference signal quality value based on the signal quality values,
means for comparing the reference signal quality value with a predefined limit,
means for defining a target data rate for messages from the end device at least partly based on the comparison of the reference signal quality value with the predefined limit,
means for defining a target transmission power for messages from the end device at least partly based on the comparison of the reference signal quality value with the predefined limit, and
means for transmitting at least one of the defined target data rate and target transmission power to the end device,
   characterized in that determining the reference signal quality value comprises:
grouping the signal quality values by propagation channel,
determining a performance of each propagation channel,
selecting a quality of service parameter M, wherein M is an integer greater than zero,
selecting the Mth best propagation channel based on the determined performance, and
determining the reference signal quality value based on the signal quality values associated with the selected propagation channel.

40. A non-transitory computer readable medium having stored thereon a set of computer readable instructions that, when executed by at least one processor, cause a server of an LPWAN to at least:
receive, in the server, a plurality of messages from an end device of the LPWAN, the plurality of messages each having an associated signal quality value and data rate,
determine a reference signal quality value based on the signal quality values,
compare the reference signal quality value with a predefined limit,
define a target data rate for messages from the end device at least partly based on the comparison of the reference signal quality value with the predefined limit,
define a target transmission power for messages from the end device at least partly based on the comparison of the reference signal quality value with the predefined limit, and
transmit at least one of the defined target data rate and target transmission power to the end device,
   characterized in that determining the reference signal quality value comprises:
grouping the signal quality values by propagation channel,
determining a performance of each propagation channel,
selecting a quality of service parameter M, wherein M is an integer greater than zero,
selecting the Mth best propagation channel based on the determined performance, and
determining the reference signal quality value based on the signal quality values associated with the selected propagation channel.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

1. A method for quality of service implementation in a server of a low power wide area network (LPWAN), the method comprising the steps of:
receiving, in the server, a plurality of messages from an end device of the LPWAN, the plurality of messages each having an associated signal quality value and data rate,
determining a reference signal quality value based on the signal quality values,
comparing the reference signal quality value with a predefined limit,
defining a target data rate for messages from the end device at least partly based on the comparison of the reference signal quality value with the predefined limit,
defining a target transmission power for messages from the end device at least partly based on the comparison of the reference signal quality value with the predefined limit, and
transmitting at least one of the defined target data rate and target transmission power to the end device,
wherein determining the reference signal quality value comprises:
grouping the signal quality values by propagation channel,
determining a performance of each propagation channel,
selecting a quality of service parameter M, wherein M is an integer greater than zero,
selecting the Mth best propagation channel based on the determined performance, and
determining the reference signal quality value based on the signal quality values associated with the selected propagation channel.

2. The method of claim 1, wherein determining the reference signal quality further comprises:
selecting a quality of service parameter N, wherein N is an integer greater than zero, and
selecting the Nth largest signal quality value from the selected propagation channel as the reference signal quality.

3. The method of claim 2, wherein the quality of service parameter N is greater than 1.

4. The method of claim 1, wherein the reference signal quality is a function of received signal quality values.

5. The method of claim 1, wherein the quality of service parameter M is greater than 1.

6. The method of claim 1, wherein M is a function of the determined performance of each propagation channel.

7. The method of claim 1, wherein the reference signal quality value is the median of the signal quality values associated with the selected propagation channel.

8. The method of claim 1, wherein the reference signal quality value is a quantile of the signal quality values associated with the selected propagation channel.

9. The method of claim 1, wherein the predefined limit comprises a table of signal quality values and associated data rates.

10. The method of claim 1, wherein the target data rate and target transmission power are selected such that they will enable demodulation of a message signal received from the end device.

11. The method of claim 1, wherein the signal quality value is selected or derived from at least one of: a Signal to Noise Ratio (SNR), a Received Signal Strength Indicator (RSSI), a Packet Error Rate (PER), and their function.

12. A method for broadcast optimization in a low power wide area network (LPWAN) comprising at least an end device, a plurality of gateways and a server, the method comprising the steps of:
receiving, in the server, a plurality of messages broadcast from the end device, the plurality of messages each having an associated signal quality value and data rate,
determining a reference signal quality value based on the signal quality values,
comparing the reference signal quality value with a predefined limit,
defining a target data rate for messages from the end device at least partly based on the comparison of the reference signal quality value with the predefined limit,
defining a target transmission power for messages from the end device at least partly based on the comparison of the reference signal quality value with the predefined limit, and
transmitting at least one of the defined target data rate and target transmission power to the end device,
wherein determining the reference signal quality value comprises:
grouping the signal quality values by propagation channel,
determining a performance of each propagation channel,
selecting a quality of service parameter M, wherein M is an integer greater than zero,
selecting the Mth best propagation channel based on the determined performance, and
determining the reference signal quality value based on the signal quality values associated with the selected propagation channel.

13. The method of claim 12, wherein the end device broadcasts within the sub-Ghz radio frequency band.

14. A non-transitory computer readable medium having stored thereon a set of computer readable instructions that, when executed by at least one processor, cause at least one apparatus of an LPWAN to at least perform the method of claim 1.

15. A computer program configured to cause a method in accordance with claim 14.

16. A server for a low power wide area network (LPWAN), the server comprising at least one processing core, at least one memory including computer program code, the at least one memory and the computer program code being configured to, with the at least one processing core, cause the server at least to:
receive a plurality of messages from an end device of the LPWAN, the plurality of messages each having an associated signal quality value and data rate,
determine a reference signal quality value based on the signal quality values,
compare the reference signal quality value with a predefined limit,
define a target data rate for messages from the end device at least partly based on the comparison of the reference signal quality value with the predefined limit,
define a target transmission power for messages from the end device at least partly based on the comparison of the reference signal quality value with the predefined limit, and
transmit at least one of the defined target data rate and target transmission power to the end device,
wherein determining the reference signal quality value comprises:
grouping the signal quality values by propagation channel,
determining a performance of each propagation channel,
selecting a quality of service parameter M, wherein M is an integer greater than zero,
selecting the Mth best propagation channel based on the determined performance, and
determining the reference signal quality value based on the signal quality values associated with the selected propagation channel.

17. The server of claim 16, wherein determining the reference signal quality further comprises:
selecting a quality of service parameter N, wherein N is an integer greater than zero, and
selecting the Nth largest signal quality value from the selected propagation channel as the reference signal quality.

18. The server of claim 17, wherein the quality of service parameter N is greater than 1.

19. The server of claim 16, wherein the reference signal quality is a function of received signal quality values.

20. The server of claim 16, wherein the quality of service parameter M is greater than 1.

21. The server of claim 16, wherein M is a function of the determined performance of each propagation channel.

22. The server of claim 16, wherein the reference signal quality value is the median of the signal quality values associated with the selected propagation channel.

23. The server of claim 16, wherein the reference signal quality value is a quantile of the signal quality values associated with the selected propagation channel.

24. The server of claim 16, wherein the predefined limit comprises a table of signal quality values and associated data rates.

25. The server of claim 16, wherein the target data rate and target transmission power are selected such that they will enable demodulation of a message signal received from the end device.

26. The server of claim 16, wherein the signal quality value is selected or derived from at least one of: a Signal to Noise Ratio (SNR), a Received Signal Strength Indicator (RSSI), a Packet Error Rate (PER), and their function.
